(19) United States
(12) Patent Application Publication
(10) Pub. No.: US 2026/0158822 A1
(43) Pub. Date: Jun. 11, 2026

(54) ACTIVE CASTER

(71) Applicant: TOYOTA JIDOSHA KABUSHIKI KAISHA, Aichi-ken (JP)

(72) Inventor: Hirotaka KOMURA, Yokohama-shi (JP)

(73) Assignee: TOYOTA JIDOSHA KABUSHIKI KAISHA, Aichi-ken (JP)

(21) Appl. No.: 19/393,568

(22) Filed: Nov. 19, 2025

(30) Foreign Application Priority Data
Dec. 9, 2024 (JP) 2024-214404

(51) Int. Cl. B60B 33/00; B60B 33/02; B60K 7/00

(52) U.S. Cl. CPC B60B 33/0068; B60B 33/0039; B60B 33/0049; B60B 33/0055; B60B 33/0076; B60B 33/02; B60K 7/0007; B60B 2900/541; B60K 2007/003; B60K 2007/0084

(57) ABSTRACT

To provide an active caster that facilitates replacement of a wheel. An active caster according to the present disclosure is adapted to enable steering of a single wheel by interference drive. An active caster includes a vertically extending steering axis, a horizontally extending axle, and a wheel connected to the axle. The active caster has both an offset s of the axle with respect to the steering axis T in a horizontal direction orthogonal to a direction in which the axle extends, and an offset d of the wheel with respect to the steering axis T in a direction in which the axle extends.

### CROSS REFERENCE TO RELATED APPLICATIONS

This application is based upon and claims the benefit of priority from Japanese patent application No. 2024-214404, filed on Dec. 9, 2024, the disclosure of which is incorporated herein in its entirety by reference.

### BACKGROUND

The present disclosure relates to an active caster.

Patent Literature 1 discloses an active caster capable of traveling omnidirectionally.
[Patent Literature 1] Japanese Unexamined Patent Application Publication No. Publication No. 2016-049921

### SUMMARY

Conventional interference drive type active single-wheel casters transmit rotational force to both sides of an axle, and there is a problem that it is not easy to replace the wheel.

The present disclosure is made in view of the above background, and an object of the present disclosure is to provide an active caster that facilitates replacement of a wheel.

An active caster according to the present disclosure is adapted to enable steering of a single wheel by interference drive, and includes:
a vertically extending steering axis;
a horizontally extending axle; and
a wheel rotating about the axle, in which
the active caster has both
an offset s of the axle with respect to the steering axis in a horizontal direction orthogonal to a direction in which the axle extends and
an offset d of the wheel with respect to the steering axis in a direction in which the axle extends.

According to the present disclosure, it is possible to provide an active caster that facilitates replacement of a wheel.

The above and other objects, features and advantages of the present disclosure will become more fully understood from the detailed description given hereinbelow and the accompanying drawings.

### BRIEF DESCRIPTION OF DRAWINGS

FIG. 1 is a perspective sectional view illustrating an active caster according to a first embodiment;

FIG. 2 is a schematic cross-sectional view illustrating the active caster according to the first embodiment;

FIG. 3 is a diagram illustrating the active caster according to the first embodiment by reference symbols; and

FIG. 4 is a diagram for describing the configuration of a vehicle including the active caster according to the first embodiment.

### DESCRIPTION OF EMBODIMENTS

### First Embodiment

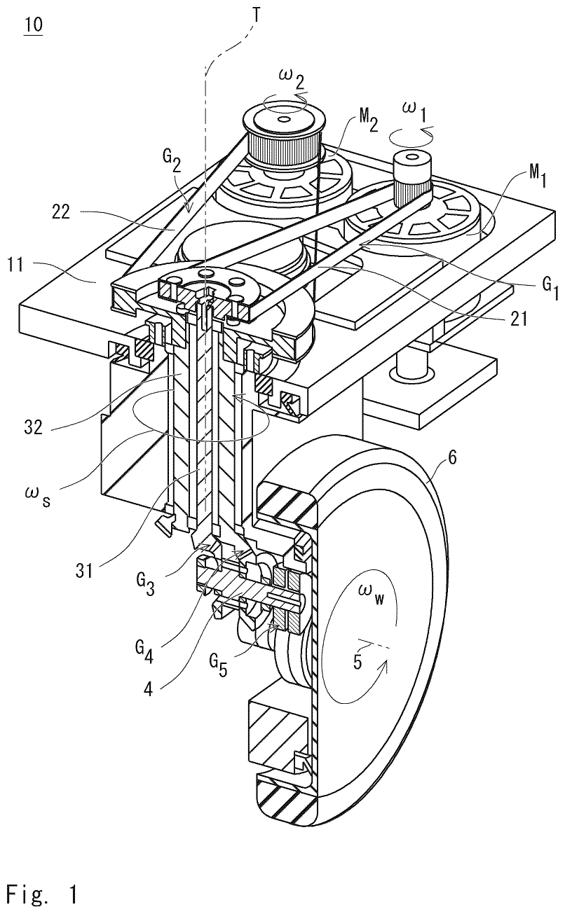

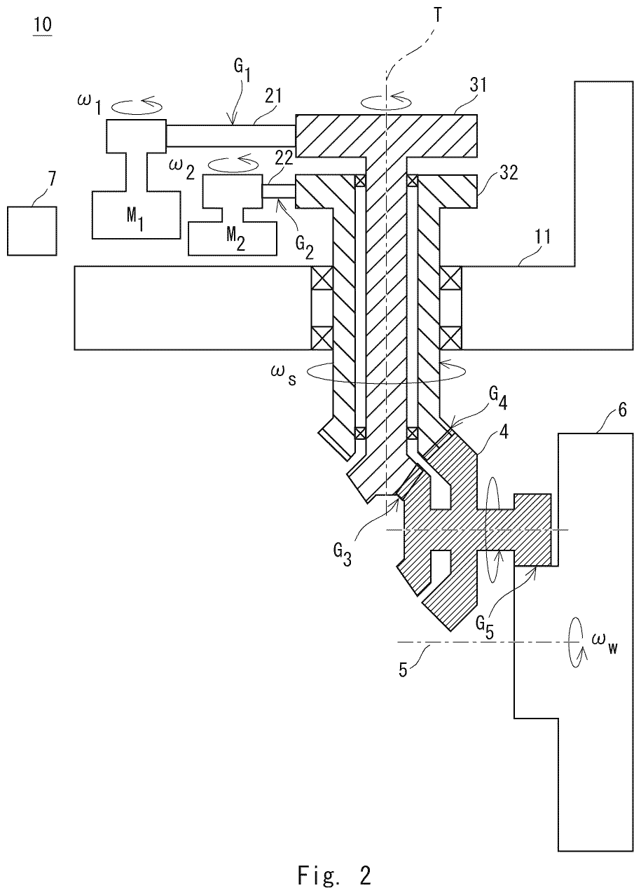

FIG. 1 is a perspective sectional view illustrating an active caster 10 according to a first embodiment. FIG. 2 is a diagram describing the configuration of the active caster 10. The active caster 10 includes a main body 11, motors M₁ and M₂, timing belts 21 and 22, rotary cylinders 31 and 32, an intermediate axis 4, an axle 5, a wheel 6, and a control unit 7.

The motors M₁ and M₂ may be supported by the main body 11. The motors M₁ and M₂ may be motors of the same performance.

The timing belt 21 is hooked to the output shaft of the motor M₁ and the rotary cylinder 31. The timing belt 22 is hooked to the output shaft of the motor M₂ and the rotary cylinder 32. The rotary cylinder 31 is rotatable about a vertical steering axis T upon rotation of the motor M₁. The rotary cylinder 32 is rotatable about the steering axis T upon rotation of the motor M₂.

The intermediate axis 4 basically has a cylindrical body extending in the horizontal direction. A second spur gear meshing with a first spur gear fixed to the wheel 6 is fixed to one end of the intermediate axis 4. A third bevel gear meshing with a first bevel gear fixed to a lower part of the rotary cylinder 31 is fixed to the other end of the intermediate axis 4. A fourth bevel gear meshing with a second bevel gear fixed to a lower part of the rotary cylinder 32 is fixed to the intermediate axis 4. A fourth bevel gear is arranged between a second spur gear and a third spur gear. The wheel 6 is rotatable about the axle 5. The axle 5 extends horizontally. The shaft on which the first spur gear is fixed can may be the axle 5.

Let G₁ be the rotational speed transmission ratio of a first rotation transmission mechanism including the timing belt 21. Let G₂ be the rotational speed transmission ratio of a second rotation transmission mechanism including the timing belt 22. Let G₃ be the rotational speed transmission ratio of a third rotation transmission mechanism including the first bevel gear of the rotary cylinder 31 and the third bevel gear of the intermediate axis 4. Let G₄ be the rotational speed transmission ratio of a fourth rotation transmission mechanism including the second bevel gear of the rotary cylinder 32 and the fourth bevel gear of the intermediate axis 4. Let G₅ be the rotational speed transmission ratio of a fifth rotation transmission mechanism including the second spur gear of the intermediate axis 4 and the first spur gear of the wheel 6.

The active caster 10 may be provided with a supporting member which rotatably supports the intermediate axis 4 and the axle 5 about the turning the steering axis T. This supporting member may serve as the steering axis T.

For example, upon rotation of the rotary cylinders 31 and 32 in the opposite directions, the direction in which the rotary cylinder 31 causes the intermediate axis 4 to rotate is opposite to the direction in which the rotary cylinder 32 causes the intermediate axis 4 to rotate, and therefore the wheel 6 does not rotate about the axle 5 but rotates about the steering axis T. The wheel 6 rotates about the axle 5 upon rotation of the rotary cylinders 31 and 32 in the same direction.

Let the rotational speed of the output shaft of the motor M₁ be ω₁, and the rotational speed of the output shaft of the motor M₂ be ω₂. Let the rotational speed of the wheel 6 about the axle 5 be ω_{w} and rotational speed of the wheel 6 about the steering axis T be ωₛ. The arcuate arrow represents the positive direction of rotation. G₁ to G₄ can be positive or negative real numbers.

The active caster enables steering of the wheel 6 by interference drive. The rotational speed ω₁ of the motor M₁ is transmitted to the rotation of the wheel 6 about the steering axis T via the first rotation transmission mechanism, and the rotational speed ω₂ of the motor M₂ is transmitted to the rotation of the wheel 6 about the steering axis T via the second rotation transmission mechanism. The rotational speed ω₁ of the motor M₁ is transmitted to the rotation of the intermediate axis 4 via the first rotation transmission mechanism and the third rotation transmission mechanism, and the rotational speed ω₂ of the motor M₂ is transmitted to the rotation of the intermediate axis 4 via the second rotation transmission mechanism and the fourth rotation transmission mechanism. The rotational speed of the intermediate axis 4 is transmitted to the rotation of the wheel 6 about the axle 5 via the fifth transmission mechanism.

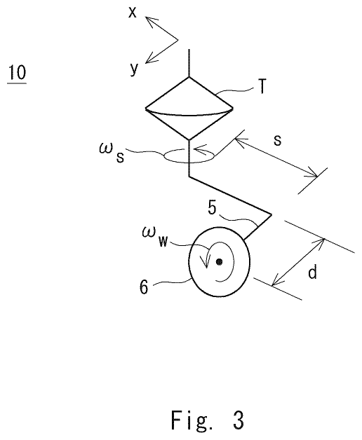

FIG. 3 is a diagram showing the active caster 10 in by reference symbols. As described above, the active caster 10 includes the steering axis T and the axle 5. Let s be the offset of the axle 5 with respect to the steering axis T in the direction orthogonal to the direction in which the axle 5 extends. Let d be the offset of the wheel 6 with respect to the steering axis T in the direction in which the axle 5 extends. Let vₓ and v_{y} be the x and y components, respectively, of the velocity of the wheel 6 rotating about the steering axis T in the xy coordinate system. The x direction corresponds to the direction orthogonal to the direction in which the axle 5 extends. The y direction corresponds to the direction in which the axle 5 extends. The following expression can be obtained, wherein l=√(s2+r2), cos α=s/l and sin α=d/l.

$$\begin{matrix}[ Expression 1 ] & \\ \{ \begin{matrix}{v}_{x} = r {ω}_{w} + l {ω}_{S} sin α \\ {v}_{y} = l {ω}_{S} cos α\end{matrix} & ( 1 )\end{matrix}$$

The following expression can be obtained, wherein v (bold face) is the vector whose components are vₓ and v_{y}.

$$\begin{matrix}[ Expression 2 ] & \\ v = ( \begin{matrix}r & d \\ 0 & s\end{matrix} ) ( \begin{matrix}{ω}_{ω} \\ {ω}_{s}\end{matrix} ) & ( 2 )\end{matrix}$$

Let Vx and Vy be the X and Y components, respectively, of the speed of the wheel 6 in the vehicle coordinate system XY of the vehicle equipped with the active caster 10. The following expression can be obtained, wherein θ is the rotation angle of the wheel 6 about the steering axis T and V (bold face) is the vector whose components are Vₓ and V_{y}.

$$\begin{matrix}[ Expression 3 ] & \\ V = ( \begin{matrix}cos θ & - sin θ \\ sin θ & cos θ\end{matrix} ) v & ( 3 )\end{matrix}$$

Referring to FIG. 2, ω₁ and ω₂ are expressed by the following expressions.

$$\begin{matrix}[ Expression 4 ] & \\ {ω}_{1} = \frac{{ω}_{w}}{{G}_{5} {G}_{3} {G}_{1}} + \frac{{ω}_{s}}{{G}_{1}} & ( 4 )\end{matrix}$$

$$\begin{matrix}[ Expression 5 ] & \\ {ω}_{2} = \frac{{ω}_{w}}{{G}_{5} {G}_{4} {G}_{2}} + \frac{{ω}_{s}}{{G}_{2}} & ( 5 )\end{matrix}$$

From Expressions (4) and (5), the following expression can be obtained. In the expressions, ω (bold face) represents a vector whose components are ω₁ and ω₂.

$$\begin{matrix}[ Expression 6 ] & \\ ( \begin{matrix}{ω}_{ω} \\ {ω}_{s}\end{matrix} ) = \frac{1}{{G}_{4} - {G}_{3}} ( \begin{matrix}{G}_{5} {G}_{4} {G}_{3} {G}_{1} & - {G}_{5} {G}_{4} {G}_{3} {G}_{2} \\ - {G}_{3} {G}_{1} & {G}_{4} {G}_{2}\end{matrix} ) ω & ( 6 )\end{matrix}$$

From Expressions (2) and (6), the following expression can be obtained.

$$\begin{matrix}[ Expression 7 ] & \\ v = \frac{1}{{G}_{4} - {G}_{3}} ( \begin{matrix}{G}_{3} {G}_{1} ( {rG}_{5} {G}_{4} - d ) & {G}_{4} {G}_{2} ( - {rG}_{5} {G}_{3} + d ) \\ {sG}_{3} {G}_{1} & {sG}_{4} {G}_{2}\end{matrix} ) ω & ( 7 )\end{matrix}$$

From Expressions (3) and (7), the following expression can be obtained.

$$\begin{matrix}[ Expression 8 ] & \\ ω = \frac{{G}_{4} - {G}_{3}}{r {G}_{5} ( {G}_{4} + {G}_{3} ) - 2 d} ( \begin{matrix}cos θ & sin θ \\ - sin θ & cos θ\end{matrix} ) ( \begin{matrix}\frac{1}{{G}_{3} {G}_{1}} & \frac{1}{{sG}_{3} {G}_{1}} ( {rG}_{5} {G}_{3} - d ) \\ - \frac{1}{{G}_{4} {G}_{2}} & \frac{1}{{sG}_{4} {G}_{2}} ( r {G}_{5} {G}_{4} - d )\end{matrix} ) V & ( 8 )\end{matrix}$$

From Expression (8), the rotational speed ω₁ of the motor M₁ and the rotational speed ω₂ of the motor M₂ with respect to any velocity vector V (bold face) can be obtained.

In order for the active caster 10 to operate, the rank of the matrix on the right side of Expression (6) must be 2. The following expression can be obtained, wherein Gᵢ≠0 (i=1 to 5).

$$\begin{matrix}[ Expression 9 ] & \\ {G}_{4} - {G}_{3} \neq 0 & ( 9 )\end{matrix}$$

Similarly, in order for the active caster 10 to operate, the rank of the matrix on the right side of Expression (7) must be 2. The following expression can be obtained, wherein Gᵢ≠0 (i=1 to 5).

$$\begin{matrix}[ Expression 10 ] & \\ 2 d - r {G}_{5} ( {G}_{3} + {G}_{4} ) \neq 0 & ( 10 )\end{matrix}$$

Referring to FIG. 2, the control unit 7 includes a hardware configuration centered on a microcomputer consisting of, for example, a CPU (Central Processing Unit), a memory, and an interface unit (I/F). The CPU performs control processing, arithmetic processing, and the like. The memory consists of a ROM (Read Only Memory) in which control programs, arithmetic programs, and the like executed by the CPU are stored. The interface unit inputs and outputs signals to and from the outside. The CPU, memory, and interface unit are interconnected via a data bus.

The control unit 7 transmits control signals to the motors M₁ and M₂ to control the rotation of the wheel 6 about the steering axis T and the rotation of the wheel 6 about the axle 5. The control unit 7 controls the motors M₁ and M₂ based on Expression (8). That is, using Expression (8), the control unit 7 calculates the rotational speed ω₁ of the motor M₁ and the rotational speed ω₂ of the motor M₂ from the speed V (bold face) of the vehicle equipped with the active caster 10. The control unit 7 transmits the control signals corresponding to the calculated rotational speed ω₁ and ω₂ to the motors M₁ and M₂.

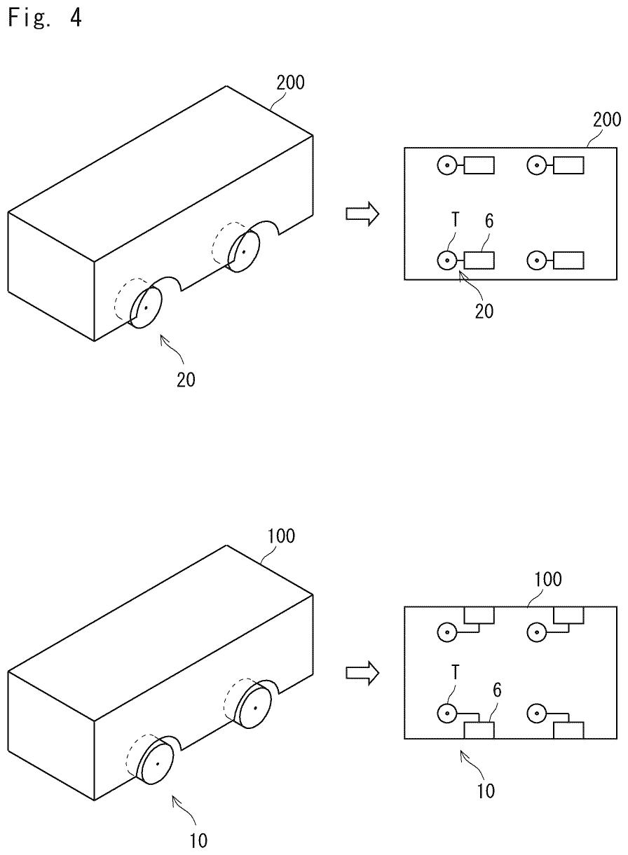

The upper left of FIG. 4 is a schematic perspective view showing the configuration of a vehicle 200 including a conventional active caster 20. The upper right of FIG. 4 is a schematic bottom view of a conventional the vehicle 200. In the conventional active caster 20, since the rotational force needs to be transmitted to both sides of the wheel 6, the wheel 6 is located close to the side of the vehicle 200. Since the active caster 20 needs to be disassembled in order to replace the wheel 6 and the wheel 6 is located distant from the side of the vehicle 200, it is not easy to perform replacement of the wheel 6.

The lower left of FIG. 4 is a schematic perspective view showing the configuration of a vehicle 100 including the active caster 10 according to the first embodiment. The lower right of FIG. 4 is a schematic bottom view showing the vehicle 100 according to the first embodiment. The distance between the side of the vehicle 100 and the wheel 6 is smaller than the distance between the side of the vehicle 100 and the steering axis T. The wheel 6 of the active caster 10 is arranged close to the side of the vehicle 100. Since the active caster 10 does not need to be disassembled and the wheel 6 is located close to the side face of the vehicle 100, it is easy to perform replacement of the wheel 6.

The active caster according to the first embodiment facilitates replacement of the wheel 6 and improves the design of a vehicle provided with the wheel 6.

It should be noted that the present disclosure is not limited to the above-described embodiment and can be appropriately changed without departing from the purport.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An active caster adapted to enable steering of a single wheel by interference drive, comprising:
a vertically extending steering axis;
a horizontally extending axle; and
a wheel rotating about the axle, wherein
the active caster has both
an offset s of the axle with respect to the steering axis in a horizontal direction orthogonal to a direction in which the axle extends and
an offset d of the wheel with respect to the steering axis in a direction in which the axle extends.

2. The active caster according to claim 1, wherein
the active caster includes: a first motor; a second motor; a first to a fifth rotation transmission mechanisms; a horizontally extending intermediate axis; and a control unit,
a first rotational speed ω₁ of the first motor is transmitted to a rotation of the wheel about the steering axis via the first rotation transmission mechanism and a second rotational speed ω₂ of the second motor is transmitted to a rotation of the wheel about the steering axis via the second rotation transmission mechanism,
the first rotational speed ω₁ is transmitted to a rotation of the intermediate axis via the first rotation transmission mechanism and the third rotation transmission mechanism; and the second rotational speed ω₂ is transmitted to a rotation of the intermediate axis via the second rotation transmission mechanism and the fourth rotation transmission mechanism,
a rotational speed of the intermediate axis is transmitted to the rotation of the wheel about the axle via the fifth rotation transmission mechanism,
the control unit controls the first motor and the second rotation transmission mechanism based on the following expression, wherein the rotational speed transmission ratios in the first to fifth motors are G₁ to G₅, respectively, the velocity vector of the vehicle equipped with the active caster is V (bold face), the rotation angle of the wheel about the steering axis is θ, and the vector whose components are ω₁ and ω₂ is ω (bold face).
$$\begin{matrix}[ Expression 1 ] & \\ ω = \frac{{G}_{4} - {G}_{3}}{r {G}_{5} ( {G}_{4} + {G}_{3} ) - 2 d} ( \begin{matrix}cos θ & sin θ \\ - sin θ & cos θ\end{matrix} ) ( \begin{matrix}\frac{1}{{G}_{3} {G}_{1}} & \frac{1}{{sG}_{3} {G}_{1}} ( {rG}_{5} {G}_{3} - d ) \\ - \frac{1}{{G}_{4} {G}_{2}} & \frac{1}{{sG}_{4} {G}_{2}} ( r {G}_{5} {G}_{4} - d )\end{matrix} ) V & \end{matrix}$$

3. The active caster according to claim 2, wherein 2d−rG₅ (G₃+G₄)≠0 holds true.

4. The active caster according to claim 2, wherein G₄−G₃≠0 holds true.

5. The active caster according to claim 1, wherein a distance between a side face of the vehicle provided with the wheel and the wheel is smaller than a distance between the side face of the vehicle and the steering axis.
